(19) United States
(12) Patent Application Publication
(10) Pub. No.: US 2023/0128122 A1
(43) Pub. Date: Apr. 27, 2023

(54) DATA PROCESSING DEVICE, DATA PROCESSING METHOD, AND COMPUTER-READABLE RECORDING MEDIUM STORING DATA PROCESSING PROGRAM

(71) Applicant: FUJITSU LIMITED, Kawasaki-shi (JP)

(72) Inventor: Shinji YAMASHITA, Kawasaki (JP)

(73) Assignee: FUJITSU LIMITED, Kawasaki-shi (JP)

(21) Appl. No.: 17/851,879

(22) Filed: Jun. 28, 2022

(30) Foreign Application Priority Data
Oct. 26, 2021 (JP) 2021-174274

(51) Int. Cl. H04L 43/067; H04L 43/0817; H04L 41/16

(52) U.S. Cl. CPC H04L 43/067; H04L 43/0817; H04L 41/16

(57) ABSTRACT

A data processing device performs clustering time-series data. The data processing device includes a memory, and a processor coupled to the memory and configured to: collect a plurality of pieces of first time-series data that belongs to a target period for clustering; calculate, when the first time-series data contains an outlier that represents a local peak, a degree of anomaly of the outlier, based on second time-series data in a past for a period that corresponds to the first time-series data; determine whether or not the degree of anomaly is equal to or higher than an anomaly standard for the outlier; remove, when the degree of anomaly is equal to or higher than the anomaly standard, the outlier from the first time-series data; and cluster the first time-series data after removing the outlier.

### CROSS-REFERENCE TO RELATED APPLICATION

This application is based upon and claims the benefit of priority of the prior Japanese Patent Application No. 2021-174274, filed on Oct. 26, 2021, the entire contents of which are incorporated herein by reference.

### FIELD

The embodiments discussed herein are related to a data processing device, a data processing method, and a data processing program.

### BACKGROUND

As one of the machine learning algorithms by artificial intelligence (AI), a clustering technique for classifying time-series data into a plurality of clusters is known. In addition, a technique for constructing a prediction model that predicts future time-series data based on past time-series data is known. In this technique, it has been proposed to add corrections such as removal of anomaly values to the past time-series data, segment the corrected past time-series data if desired, and construct learning data to be used in the prediction model.

Besides, there is also known a technique of selecting a time-series model obtained by modeling traffic fluctuations in time series based on historical information on traffic flowing through a network, and setting parameter values of the time-series model to generate a traffic model. In this technique, it has been proposed to work out a predicted value of traffic from the traffic model and detect a traffic anomaly based on the predicted value and the measured value of the traffic.

Japanese Laid-open Patent Publication No. 2020-004328, International Publication Pamphlet No. WO 2017/017740, Japanese Laid-open Patent Publication No. 2009-237832, and Japanese Laid-open Patent Publication No. 2018-195929 are disclosed as related art.

### SUMMARY

According to an aspect of the embodiments, a data processing device includes a memory, and a processor coupled to the memory and configured to: collect a plurality of pieces of first time-series data that belongs to a target period for clustering; calculate, when the first time-series data contains an outlier that represents a local peak, a degree of anomaly of the outlier, based on second time-series data in a past for a period that corresponds to the first time-series data; determine whether or not the degree of anomaly is equal to or higher than an anomaly standard for the outlier; remove, when the degree of anomaly is equal to or higher than the anomaly standard, the outlier from the first time-series data; and cluster the first time-series data after removing the outlier.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an example of a network system;

FIG. 2 is an example of a flow table;

FIG. 3 is an example of the hardware configuration of an operation management server;

FIG. 4 is an example of the functional configuration of the operation management server;

FIG. 5 is an example of a plurality of pieces of time-series traffic data;

FIG. 6 is an example of traffic data normalization;

FIG. 7 is a flowchart illustrating an example of processing executed by the operation management server;

FIG. 8 is a diagram explaining the degree of anomaly equal to or higher than an anomaly standard and removal of an outlier;

FIG. 9 is a diagram explaining the degree of anomaly lower than the anomaly standard and maintenance of an outlier;

FIG. 10A is an example of a cluster pattern; and

FIG. 10B is another example of the cluster pattern.

### DESCRIPTION OF EMBODIMENTS

When time-series data belonging to a target period for clustering contains an anomaly value, this anomaly value is sometimes not an anomaly value when past time-series data is taken into consideration. In such a case, clustering the time-series data by uniformly (or simply) removing the anomaly value from the time-series data is likely to deteriorate the accuracy of clustering. If the time-series data is clustered by including the past time-series data as well into the time-series data belonging to the target period, there is a possibility that the time-series data targeted for clustering may increase, and the computation load involved in clustering may rise.

Thus, one aspect aims to provide a data processing device, a data processing method, and a data processing program that improve the clustering accuracy of time-series data.

Hereinafter, modes for carrying out the present embodiments will be described with reference to the drawings.

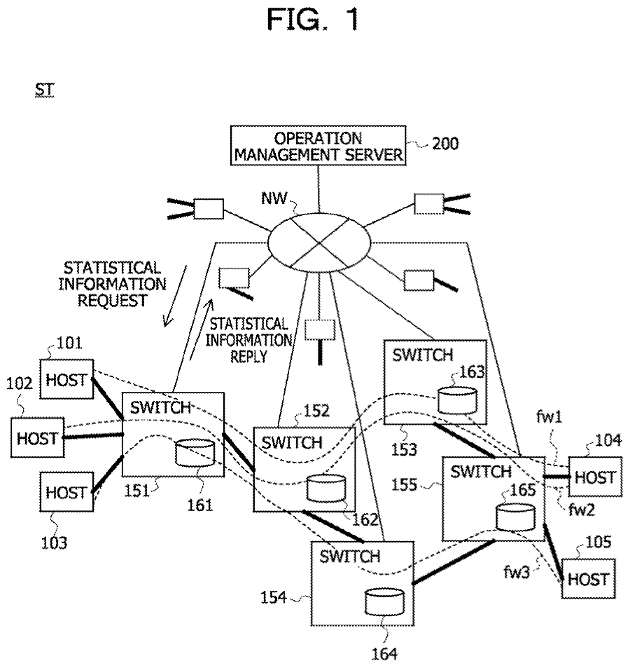

As illustrated in FIG. 1, a network system ST includes hosts 101 to 105, switches (communication nodes) 151 to 155, and an operation management server 200. The operation management server 200 is an example of the data processing device. The respective switches 151 to 155 are independently installed at a variety of sites (such as regional branch offices of a company as an example). The hosts 101, 102, and 103 may be installed at the same site as the site of the switch 151 or may be installed at different sites from the site of the switch 151. The hosts 104 and 105 may be installed at the same site as the site of the switch 155 or may be installed at different sites from the site of the switch 155. The switches 151 to 155 are OpenFlow switches having flow tables 161 to 165, respectively. Instead of the OpenFlow switches, for example, L2 switches (or Ethernet (registered trademark) switches) having management information bases (MIBs) may be adopted as the switches 151 to 155. For example, although the OpenFlow switches will be described as an example in the present embodiment, the L2 switches can also be used in the present embodiment. Details will be described later, but statistical information for each flow is registered in the flow tables 161 to 165. Note that the flow refers to a flow of a set of packets having the same attributes. This allows the representation of the flow of traffic linking between hosts. Meanwhile, in the case of the L2 switch, statistical information similar to the above statistical information is registered in the MIB.

A connection relationship in the network system ST will be described. The host 101 (for example, Internet protocol (IP) address: 10.1.1.1) is connected to a second port of the switch 151. The host 102 (for example, IP address: 10.2.2.2) is connected to a third port of switch 151. The host 103 (for example, IP address: 10.3.3.3) is connected to a fourth port of the switch 151. A first port of the switch 151 is connected to the first port of the switch 152. The second port of the switch 152 is connected to the first port of the switch 153. The third port of the switch 152 is connected to the first port of the switch 154. The second port of the switch 153 is connected to the first port of the switch 155. The second port of the switch 154 is connected to the second port of the switch 155.

The host 104 (for example, IP address: 10.4.4.4) is connected to the third port of the switch 155. The host 105 (for example, IP address: 10.5.5.5) is connected to the fourth port of the switch 155. The hosts 101 and 104 communicate with each other by a flow fw1 passing through the switches 151, 152, 153, and 155. The hosts 102 and 104 communicates with each other by a flow fw2 passing through the switches 151, 152, 153, and 155. The hosts 103 and 105 communicate with each other by a flow fw3 passing through the switches 151, 152, 154, and 155.

The operation management server 200 connects individually to a variety of switches including the switches 151 to 155 via a communication network NW, transmits statistical information requests to the connected switches, and receives statistical information replies returned from the connected switches. The statistical information reply includes the above-mentioned statistical information as traffic data. Accordingly, when the OpenFlow switch is adopted, the operation management server 200 acquires the statistical information registered in the flow tables 161 to 165. When the L2 switch is adopted, the operation management server 200 acquires the statistical information registered in the MIB, using a simple network management protocol (SNMP). The operation management server 200 periodically transmits the statistical information request, such as in several-second units or in several-minute units, and receives the statistical information reply. Accordingly, the operation management server 200 periodically collects traffic data from a variety of switches. This allows the operation management server 200 to collect time-series traffic data. Note that the communication network NW includes, for example, any one or both of a local area network (LAN) and the Internet.

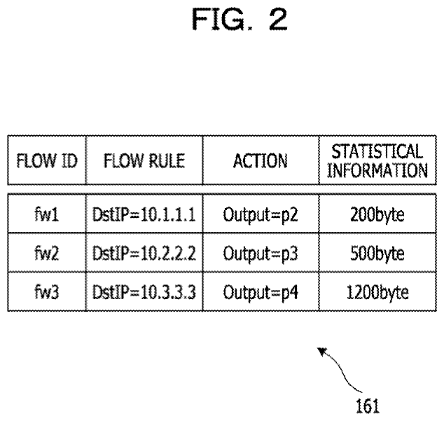

The flow table 161 included in the switch 151 will be described with reference to FIG. 2. Since the flow tables 162 to 165 included in the switches 152 to 155, respectively, are basically similar to the flow table 161, detailed description thereof will be omitted. Note that, when the L2 switch is adopted instead of the OpenFlow switch, the MIB of the L2 switch may be adopted instead of the flow tables 161 to 165. Details will be described later, but like the flow tables 161 to 165, the MIB also contains statistical information such as the number of bytes in the packet, as one of the items.

The flow table 161 contains a plurality of items such as a flow identifier (ID), a flow rule, an action, and statistical information, as one flow entry. In FIG. 2, three flow entries are registered in the flow table 161. The flow ID is an identifier that identifies the flow. The flow rule represents a matching condition with a packet header. For example, the rule has various attributes such as a switch port, a transmission source media access control (MAC) address, a destination IP address, a transmission source transmission control protocol (TCP) port number, and a destination TCP port number. The action represents a packet process executed based on an OpenFlow protocol when the packet header and the rule match. The statistical information represents a matching status for each flow entry. For example, the matching status includes the number of bytes in the matched packet. The number of packets for the matched packets may be included together with the number of bytes of the packet. In FIG. 2, for example, the flow rule includes “DstIP=10.2.2.2” as the destination IP address for the flow ID “fw2”. In addition, “Output=p3” representing the output to the third port is associated with the flow ID “fw2”. Furthermore, “500 bytes” is included as statistical information for the flow ID “fw2”.

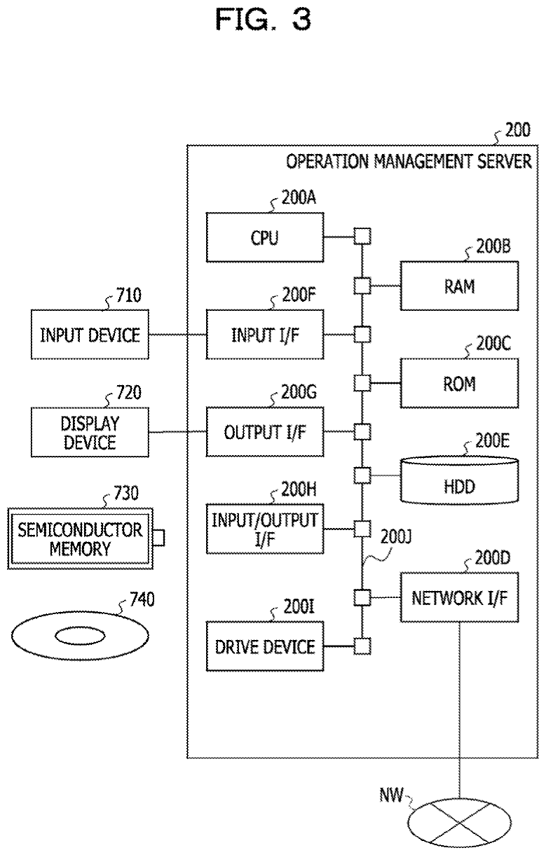

Next, a hardware configuration of the operation management server 200 will be described with reference to FIG. 3. Note that, since the hardware configurations of the hosts 101 to 105 are basically hardware configurations similar to the hardware configuration of the operation management server 200, detailed description thereof will be omitted. Meanwhile, the hardware configurations of the switches 151 to 155 may be implemented by a hardware configuration similar to the hardware configuration of the operation management server 200, or may be implemented by a hardware circuit such as an application specific integrated circuit (ASIC) or a field programmable gate array (FPGA).

The operation management server 200 includes a central processing unit (CPU) 200A as a processor, a random access memory (RAM) 200B and a read only memory (ROM) 200C as a memory, and a network interface (I/F) 200D. The operation management server 200 may include at least one of a hard disk drive (HDD) 200E, an input I/F 200F, an output I/F 200G, an input/output I/F 200H, and a drive device 2001 if desired. The CPU 200A to the drive device 2001 are connected to each other by an internal bus 200J. For example, the operation management server 200 may be implemented by a computer.

An input device 710 is connected to the input I/F 200F. The input device 710 includes a keyboard and a mouse. A display device 720 is connected to the output I/F 200G. The display device 720 includes a liquid crystal display. A semiconductor memory 730 is connected to the input/output I/F 200H. For example, the semiconductor memory 730 includes a universal serial bus (USB) memory, a flash memory, and the like. The input/output I/F 200H reads the data processing program stored in the semiconductor memory 730. The input I/F 200F and the input/output I/F 200H include, for example, USB ports. The output I/F 200G includes, for example, a display port.

A portable recording medium 740 is inserted into the drive device 2001. Examples of the portable recording medium 740 include a removable disk such as a compact disc (CD)-ROM and a digital versatile disc (DVD). The drive device 2001 reads the data processing program recorded on the portable recording medium 740. The network I/F 200D includes, for example, a LAN port. The network I/F 200D is connected to the communication network NW.

The data processing program stored in the ROM 200C or the HDD 200E is temporarily stored in the RAM 200B described above by the CPU 200A. The data processing program recorded on the portable recording medium 740 is temporarily stored in the RAM 200B by the CPU 200A. When the CPU 200A executes the stored data processing program, the CPU 200A implements various functions to be described later and additionally, executes various processes to be described later. Note that the data processing program is only supposed to be in accordance with a flowchart to be described later.

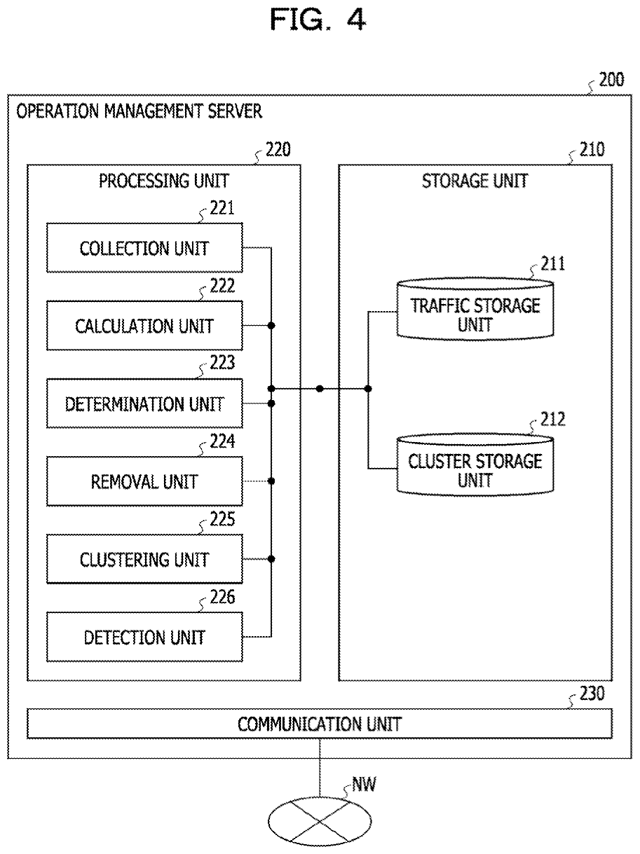

Next, a functional configuration of the operation management server 200 will be described with reference to FIGS. 4 to 6. Note that FIG. 4 illustrates the main part of the functions of the operation management server 200.

As illustrated in FIG. 4, the operation management server 200 includes a storage unit 210, a processing unit 220, and a communication unit 230. The storage unit 210 may be implemented by one or both of the RAM 200B and the HDD 200E described above. The processing unit 220 may be implemented by the CPU 200A described above. The communication unit 230 may be implemented by the network I/F 200D described above. Accordingly, the storage unit 210, the processing unit 220, and the communication unit 230 are connected to each other.

The storage unit 210 includes a traffic storage unit 211 and a cluster storage unit 212. The processing unit 220 includes a collection unit 221, a calculation unit 222, and a determination unit 223. In addition, the processing unit 220 includes a removal unit 224, a clustering unit 225, and a detection unit 226.

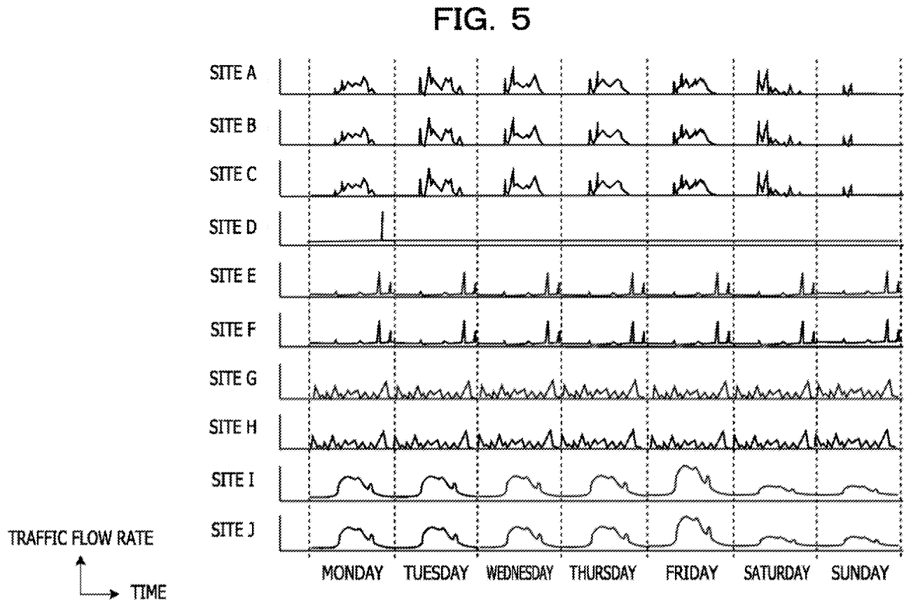

The collection unit 221 periodically collects the statistical information as traffic data from a variety of switches including the switches 151 to 155 via the communication unit 230. The collection unit 221 saves the collected traffic data in the traffic storage unit 211. This causes the traffic storage unit 211 to store a plurality of pieces of time-series traffic data corresponding to, for example, a plurality of sites A, B, . . . , and J in a one-to-one manner, as illustrated in FIG. 5. A traffic flow rate represents the total sum of the number of bytes of packets per unit time at each site. Although not depicted, the traffic storage unit 211 stores not only the traffic data of the week including the time of collection but also the traffic data of a past week before that week. The collection unit 221 separately collects time-series traffic data of each site belonging to the target period for clustering (for example, the clustering target week) from the traffic storage unit 211, based on an instruction from an operation manager of the network system ST.

When the time-series traffic data collected by the collection unit 221 contains an outlier that represents a local peak, the calculation unit 222 calculates the degree of anomaly of the outlier, based on past traffic data in the period corresponding to the collected traffic data. For example, the calculation unit 222 performs machine learning on the past traffic data and calculates the predicted value of the collected traffic data in the target period, based on the learning result. When the predicted value has been calculated, the calculation unit 222 calculates the degree of anomaly based on the difference between the measured value of the collected traffic data in the target period and the calculated predicted value (such as the square of the difference or the absolute value of the difference as an example).

Note that, as for the predicted value, the calculation unit 222 calculates the predicted value based on the learning result and a known analysis model that analyzes the time-series data. For example, the analysis model includes an auto-regressive integrated moving average (ARIMA) model, an auto-regressive (AR) model, a regression linear model, and the like.

The determination unit 223 determines whether or not the degree of anomaly calculated by the calculation unit 222 is equal to or higher than an anomaly standard for the outlier. The anomaly standard represents a threshold value for determining whether or not the outlier is anomalous. When the degree of anomaly is equal to or higher than the above-mentioned anomaly standard, the removal unit 224 removes the outlier from the traffic data for the target period. When the outlier has been removed, the removal unit 224 may complement the traffic data after removing the outlier, based on the values before and after the outlier, after removing the outlier. When the degree of anomaly is lower than the anomaly standard, the removal unit 224 maintains the outlier included in the traffic data for the target period.

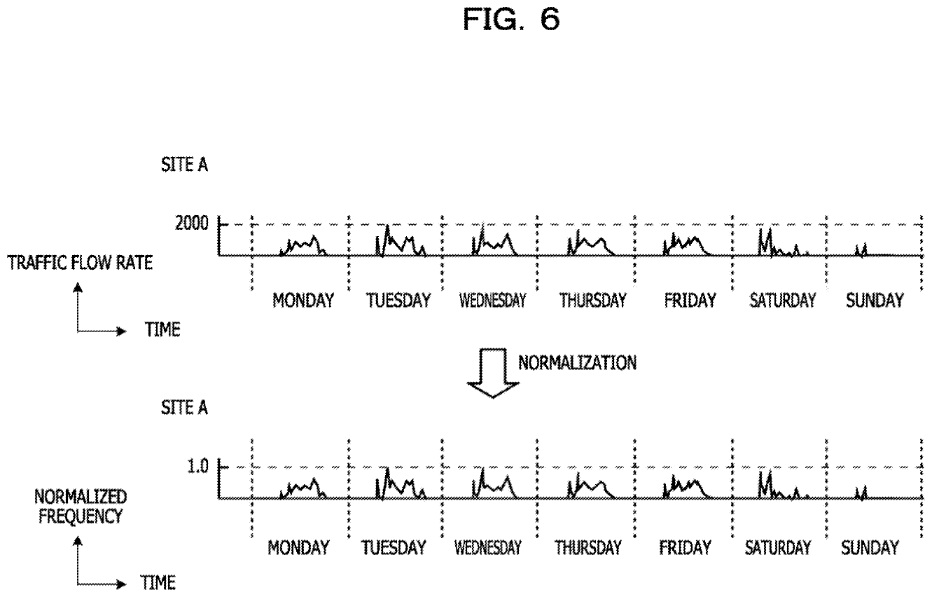

The clustering unit 225 executes normalization on each piece of traffic data, based on the maximum value of the traffic flow rate in the traffic data from which the outlier has been removed or the traffic data including the outlier. For example, in the case of the site A, as illustrated in FIG. 6, the clustering unit 225 executes normalization in which the maximum value of the traffic flow rate is specified as the maximum normalized frequency “1.0”. The same applies to the site B to the site J as in the site A. This unifies respective pieces of traffic data having variations in the maximum value of the traffic flow rate as a whole. Note that the traffic data from which the outlier has been removed may be complemented or may not be complemented. When normalization is executed on each piece of traffic data, the clustering unit 225 extracts the feature amount of each piece of normalized traffic data. For example, the clustering unit 225 extracts an hourly average normalized frequency as the feature amount of each piece of normalized traffic data. The hourly average normalized frequency corresponds to the hourly average traffic flow rate.

When the feature amount has been extracted, the clustering unit 225 clusters the traffic data from which the outlier has been removed, based on the feature amount and a predetermined clustering algorithm. When the removal unit 224 has complemented the traffic data after removing the outlier, the clustering unit 225 clusters the complemented traffic data based on the feature amount and the above-mentioned clustering algorithm. The clustering accuracy is improved compared with the case without complementing. When the above-mentioned degree of anomaly is lower than the anomaly standard, the clustering unit 225 clusters the traffic data including the outlier, based on the feature amount and the above-mentioned clustering algorithm. For example, when the degree of anomaly is lower than the anomaly standard, it is assumed that, even if the traffic data contains an outlier, there is no influence on the deterioration of the accuracy of clustering or the influence is exceptionally small.

Note that the predetermined clustering algorithm includes known clustering algorithms such as K-means method and agglomerative nesting (AGNES), for example. When the traffic data has been clustered, the clustering unit 225 saves a plurality of clusters in the cluster storage unit 212. This causes the cluster storage unit 212 to store the plurality of clusters. A plurality of pieces of traffic data belonging to the same cluster and having similar tendencies is associated with each of the plurality of clusters.

The detection unit 226 extracts a plurality of clusters from the cluster storage unit 212 and aggregates the traffic data for each extracted cluster to generate aggregated traffic data. In more detail, the detection unit 226 generates the aggregated traffic data obtained by adding (or accumulating) the traffic flow rates of a plurality of pieces of traffic data belonging to each cluster, for each extracted cluster. The detection unit 226 detects an anomaly in the aggregated traffic data for each cluster. For example, the detection unit 226 compares the aggregated traffic data and a fixed anomaly detection threshold value and detects an anomaly in the aggregated traffic data when the anomaly detection threshold value is exceeded. This allows the operation manager to grasp the anomaly of the network system ST at an early stage. Note that the detection unit 226 may detect an anomaly in the aggregated traffic data, based on a known anomaly detection scheme such as the technique disclosed in Japanese Laid-open Patent Publication No. 2018-195929.

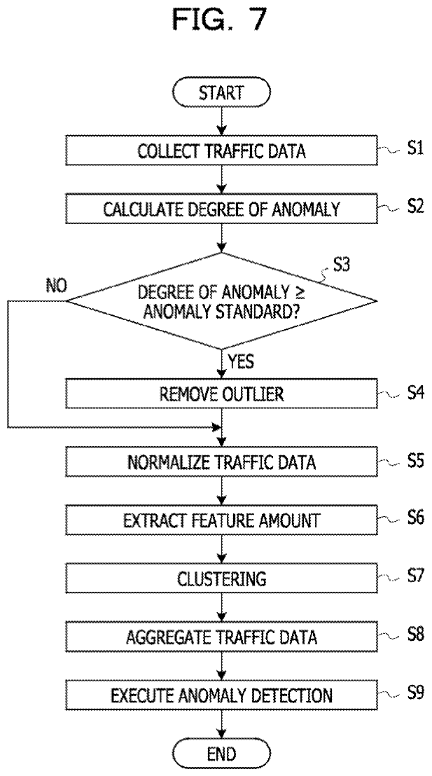

The behavior of the operation management server 200 will be described with reference to FIGS. 7 to 10B.

First, as illustrated in FIG. 7, the collection unit 221 collects traffic data (step S1). In more detail, the collection unit 221 collects a plurality of pieces of time-series traffic data belonging to the target period for clustering (refer to FIG. 5) from the traffic storage unit 211.

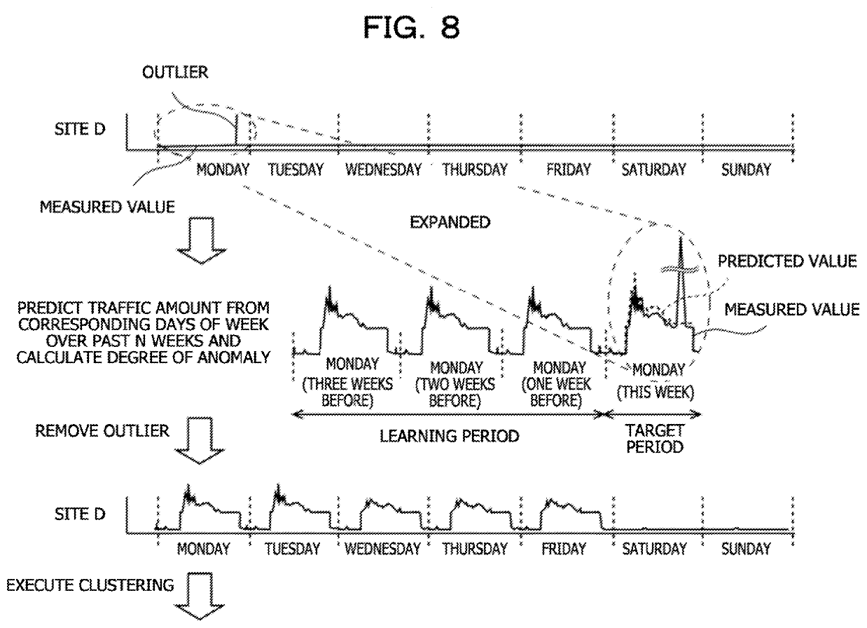

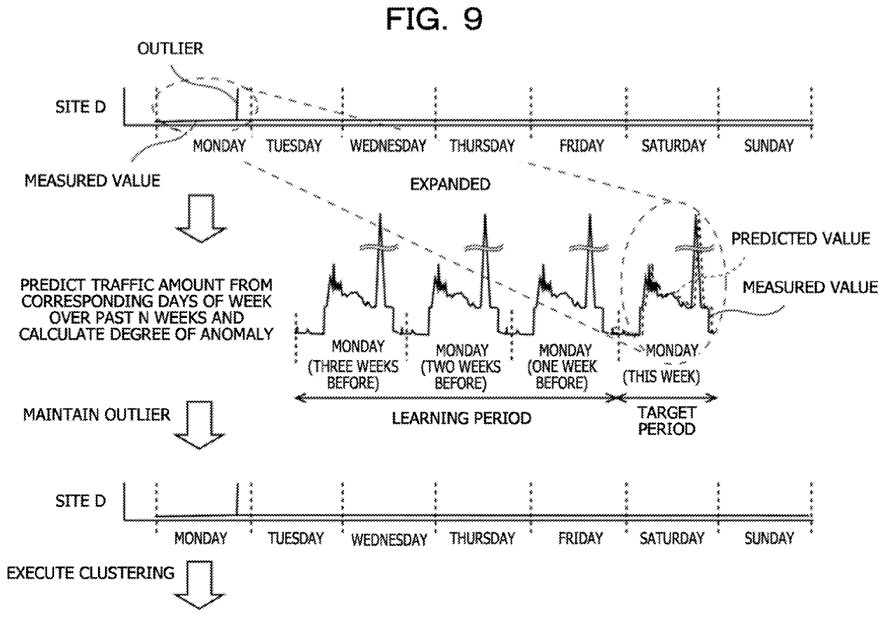

When the collection unit 221 has collected the traffic data, the calculation unit 222 calculates the degree of anomaly (step S2). For example, as illustrated in FIGS. 8 and 9, when the traffic data at the site D contains an outlier that represents a local peak, the degree of anomaly of the outlier is calculated based on past traffic data for the period corresponding to the traffic data. For example, the corresponding period is the same day of the week or the like in the past. As described above, the calculation unit 222 performs machine learning on the past traffic data and calculates the predicted value of the collected traffic data in the target period, based on the learning result. When the predicted value has been calculated, the calculation unit 222 calculates the degree of anomaly based on the squared value or the like of the difference between the measured value of the collected traffic data in the target period and the calculated predicted value.

When the calculation unit 222 has calculated the degree of anomaly, the determination unit 223 determines whether or not the degree of anomaly is equal to or higher than the anomaly standard for the outlier (step S3). For example, as illustrated in FIG. 8, when the divergence between the predicted value (broken line) and the measured value (solid line) is large, since the squared value of the difference between the measured value and the predicted value is large, the determination unit 223 determines that the degree of anomaly is equal to or higher than the anomaly standard (step S3: YES). In this case, the removal unit 224 removes the outlier from the traffic data (step S4). In more detail, the removal unit 224 removes the outlier from the traffic data and complements the outlier part. Consequently, as illustrated in FIG. 8, in the traffic data at the site D containing the outlier, a linear fine part is made precise by the outlier having been removed and complemented, and traffic data containing sawtooth-shaped waveform appears when represented in an expanded manner.

On the other hand, as illustrated in FIG. 9, when the divergence between the predicted value (broken line) and the measured value (solid line) is small, since the squared value of the difference between the measured value and the predicted value is small, the determination unit 223 determines that the degree of anomaly is lower than the anomaly standard (step S3: NO). In this case, the removal unit 224 skips the process in step S4. For example, the removal unit 224 maintains the outlier of the traffic data. Consequently, as illustrated in FIG. 9, in the traffic data at the site D containing the outlier, this outlier is maintained, and when represented without expansion, the outlier and the linear part remain, and a large change does not arise. In this manner, the graph shape of the time-series traffic data differs depending on whether the outlier is removed and complemented or the outlier is maintained.

When the outlier has been removed or the outlier is maintained, the clustering unit 225 normalizes the traffic data (step S5). Consequently, the respective pieces of traffic data of the sites A, . . . , and J are normalized (for example, refer to FIG. 6). When the traffic data has been normalized, the clustering unit 225 extracts the feature amount of each piece of normalized traffic data (step S6). When the feature amount has been extracted, the clustering unit 225 clusters the traffic data (step S7). This classifies the traffic data into several types of clusters.

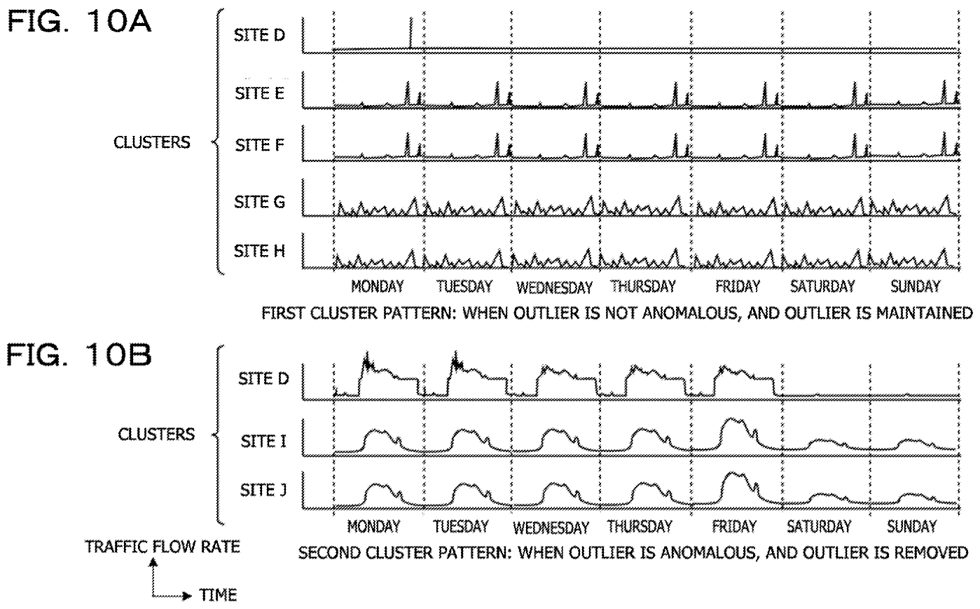

For example, when the outlier is maintained, as illustrated in FIG. 10A, the traffic data at the sites D, . . . , and H have similar tendencies and thus are classified as one cluster. Note that, in this case, if based on the traffic data illustrated in FIG. 5, it is assumed that the traffic data at the sites A, B, and C are classified as one cluster having similar tendencies apart from this cluster. In addition, it is assumed that the traffic data at the sites I and J are classified as one cluster having similar tendencies apart from these two clusters.

On the other hand, when the outlier has been removed, as illustrated in FIG. 10B, the traffic data at the sites D, I, and J have similar tendencies and thus are classified as one cluster. Note that, in this case, if based on the traffic data illustrated in FIG. 5, it is assumed that the traffic data at the sites A, B, and C are classified as one cluster having similar tendencies apart from this cluster. In addition, it is assumed that the traffic data at the sites E, . . . , and H are classified as one cluster having similar tendencies apart from these two clusters.

When the traffic data has been clustered, the detection unit 226 aggregates the traffic data for each cluster (step S8). In more detail, the detection unit 226 aggregates the traffic data for each cluster to generate the aggregated traffic data. When the aggregated traffic data has been generated, the detection unit 226 executes anomaly detection on the aggregated traffic data for each cluster (step S9) and ends the process.

As described above, according to the present embodiment, the operation management server 200 includes the collection unit 221, the calculation unit 222, the determination unit 223, the removal unit 224, and the clustering unit 225. The collection unit 221 collects a plurality of pieces of time-series traffic data belonging to the target period for clustering. When the traffic data contains an outlier that represents a local peak, the calculation unit 222 calculates the degree of anomaly of the outlier, based on past traffic data in the period corresponding to the traffic data. The determination unit 223 determines whether or not the degree of anomaly is equal to or higher than the anomaly standard for the outlier. The removal unit 224 removes the outlier from the traffic data when the degree of anomaly is equal to or higher than the anomaly standard. The clustering unit 225 clusters the traffic data after removing the outlier. With these configurations, the clustering accuracy of time-series traffic data may be improved.

In this manner, the degree of anomaly of the outlier included in the traffic data may be calculated based on the past traffic data for the period corresponding to the traffic data belonging to the target period for clustering. Then, only when the degree of anomaly is equal to or higher than the anomaly standard, the outlier may be removed from the traffic data, and the traffic data after the outlier has been removed may be clustered. Accordingly, adaptive clustering according to the degree of anomaly may be performed.

For example, according to the present embodiment, the traffic data is clustered without including the past traffic data as well into the traffic data belonging to the target period for clustering. Therefore, the traffic data targeted for clustering does not increase, and the computation load involved in clustering may be suppressed as compared with the case where the past traffic data is included as well.

Although the preferred embodiments have been described in detail thus far, the present embodiments are not limited to specific embodiments, and various modifications and alterations may be made within the scope of the present embodiments described in the claims.

For example, in the present embodiment, the time-series traffic data of the traffic flowing through the network has been described as an example of the time-series data, but the time-series data is not limited to the traffic data. For example, time-series data relating to the demanded amount and consumed amount of electric power, gas, water, heat, or the like may be adopted as the time-series data of the present embodiment.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

1. A data processing device comprising:
a memory, and
a processor coupled to the memory and configured to:
collect a plurality of pieces of first time-series data that belongs to a target period for clustering;
for each of the plurality of pieces of first time-series data,
calculate, when a piece of the plurality of pieces of the first time-series data contains an outlier that represents a local peak, a degree of anomaly of the outlier, based on second time-series data in a past for a period that corresponds to the first time-series data;
determine whether or not the degree of anomaly is equal to or higher than an anomaly standard for the outlier;
remove, when the degree of anomaly is equal to or higher than the anomaly standard, the outlier from the piece of the plurality of pieces of the first time-series data; and
cluster the plurality of pieces of the first time-series data after removing the outlier into several clusters.

2. The data processing device according to claim 1, wherein the processor is further configured to:
complement the first time-series data after removing the outlier based on values before and after the outlier; and
cluster the complemented first time-series data.

3. The data processing device according to claim 1, wherein the processor is further configured to:
cluster, when the degree of anomaly is lower than the anomaly standard, the first time-series data that includes the outlier.

4. The data processing device according to claim 1, wherein the processor is further configured to:
perform machine learning on the second time-series data and calculate the degree of anomaly based on a learning result.

5. The data processing device according to claim 4, wherein the processor is further configured to:
calculate a predicted value of the first time-series data in the target period, based on the learning result; and
calculate the degree of anomaly based on a difference between a measured value of the first time-series data in the target period and the predicted value.

6. The data processing device according to claim 5, wherein
the predicted value is calculated based on the learning result and an auto-regressive integrated moving average model.

7. A data processing method performed by a computer, the method comprising:
collecting a plurality of pieces of first time-series data that belongs to a target period for clustering; and
for each of the plurality of pieces of first time-series data,
calculating, when a piece of the plurality of pieces of the first time-series data contains an outlier that represents a local peak, a degree of anomaly of the outlier, based on second time-series data in a past for a period that corresponds to the first time-series data;
determining whether or not the degree of anomaly is equal to or higher than an anomaly standard for the outlier;
removing, when the degree of anomaly is equal to or higher than the anomaly standard, the outlier from the piece of the plurality of pieces of the first time-series data; and
clustering the plurality of pieces of the first time-series data after removing the outlier into several clusters.

8. The data processing method according to claim 7, wherein,
in the removing, complementing the first time-series data after removing the outlier based on values before and after the outlier; and
in the clustering, clustering the complemented first time-series data.

9. The data processing method according to claim 7, wherein in the clustering, when the degree of anomaly is lower than the anomaly standard, clustering the first time-series data that includes the outlier.

10. The data processing method according to claim 7, wherein in the calculating, performing machine learning on the second time-series data and calculating the degree of anomaly based on a learning result.

11. The data processing method according to claim 10, wherein in the calculating,
calculating a predicted value of the first time-series data in the target period, based on the learning result; and
calculating the degree of anomaly based on a difference between a measured value of the first time-series data in the target period and the predicted value.

12. The data processing method according to claim 11, wherein
the predicted value is calculated based on the learning result and an auto-regressive integrated moving average model.

13. A non-transitory computer-readable recording medium storing a data processing program causing a computer to perform a process comprising:
collecting a plurality of pieces of first time-series data that belongs to a target period for clustering; and
for each of the plurality of pieces of first time-series data,
calculating, when a piece of the plurality of pieces of the first time-series data contains an outlier that represents a local peak, a degree of anomaly of the outlier, based on second time-series data in a past for a period that corresponds to the first time-series data;
determining whether or not the degree of anomaly is equal to or higher than an anomaly standard for the outlier;
removing, when the degree of anomaly is equal to or higher than the anomaly standard, the outlier from the piece of the plurality of pieces of the first time-series data; and
clustering the plurality of pieces of the first time-series data after removing the outlier into several clusters.
